(19) United States
(12) Patent Application Publication
(10) Pub. No.: US 2022/0324480 A1
(43) Pub. Date: Oct. 13, 2022

(54) CONTROL DEVICE, VEHICLE, NON-TRANSITORY COMPUTER-READABLE MEDIUM, AND CONTROL METHOD

(71) Applicant: PANASONIC INTELLECTUAL PROPERTY MANAGEMENT CO., LTD., Osaka (JP)

(72) Inventors: Tomohiro TSUNEKAZU, Kanagawa (JP); Yuya MATSUMOTO, Tokyo (JP); Shota AKAURA, Kanagawa (JP)

(73) Assignee: PANASONIC INTELLECTUAL PROPERTY MANAGEMENT CO., LTD., Osaka (JP)

(21) Appl. No.: 17/847,635

(22) Filed: Jun. 23, 2022

Related U.S. Application Data
(63) Continuation of application No. PCT/JP2020/042554, filed on Nov. 16, 2020.

(30) Foreign Application Priority Data
Dec. 25, 2019 (JP) 2019-234064

(51) Int. Cl. B60W 60/00; B60W 30/18; B60W 50/14

(52) U.S. Cl. CPC B60W 60/001; B60W 30/18159; B60W 50/14; B60W 2555/60; B60W 2552/00

(57) ABSTRACT

A control device for controlling autonomous driving of a vehicle, the control device includes a processor and a memory storing instructions. The instructions, when executed by the processor, cause the control device to perform operations including: switching a control content in the autonomous driving of the vehicle based on a position of the vehicle.

### CROSS-REFERENCE TO RELATED APPLICATIONS

This is a continuation of International Application No. PCT/JP2020/042554 filed on Nov. 16, 2020, and claims priority from Japanese Patent Application No. 2019-234064 filed on Dec. 25, 2019, the entire content of which is incorporated herein by reference.

### TECHNICAL FIELD

The present disclosure relates to a control device, a vehicle, a non-transitory computer-readable medium, and a control method.

### BACKGROUND ART

JP-A-2017-061320 describes autonomous driving in a self-driving vehicle including a manual driving mode and an autonomous driving mode. The self-driving vehicle includes: condition element detection means for detecting one or more condition elements used by a host vehicle to determine whether one or more switching conditions determined in advance based on traffic regulations are satisfied; determination means for determining whether the switching conditions are satisfied based on detection output from the condition element detection means during traveling, parking, or stopping in the manual driving mode; and driving mode control means for forcibly switching the driving mode from the manual driving mode to the autonomous driving mode if the determination means determines that the switching conditions are satisfied.

### SUMMARY OF INVENTION

The present disclosure provides a control device for controlling autonomous driving of a vehicle, the control device including: a processor; and a memory storing instructions that, when executed by the processor, cause the control device to perform operations including: switching a control content in the autonomous driving of the vehicle based on a position of the vehicle.

The present disclosure provides a vehicle including the above-described control device.

The present disclosure provides a non-transitory computer-readable medium storing a program that, when executed by a processor, causes a control device included in a vehicle to perform operations including: switching a control content in autonomous driving of the vehicle based on a position of the vehicle.

The present disclosure provides a control method for controlling autonomous driving of a vehicle and to be executed by a control device, the control method including: acquiring a position of the vehicle; and switching a control content in the autonomous driving of the vehicle based on the position of the vehicle.

### BRIEF DESCRIPTION OF DRAWINGS

FIG. 1 is a top view conceptual diagram showing an example of a vehicle 500 on which autonomous driving control is performed by a control device.

FIG. 2 is a block diagram showing a configuration example of the vehicle 500 including the control device of the present disclosure.

FIG. 3 is a flowchart showing an example of the autonomous driving control of the vehicle 500 by the control device of the present disclosure.

FIG. 4 is a conceptual diagram showing a traffic regulation for a roundabout intersection.

FIG. 5 is a conceptual diagram showing a traffic regulation for a temporary stop before a railroad crossing.

FIG. 6 is a conceptual diagram showing a traffic regulation for a temporary stop at a red light in a country E.

FIG. 7 is a conceptual diagram showing a traffic regulation for a temporary stop at a yellow light.

FIG. 8 is a conceptual diagram showing a traffic regulation for a driving priority order in a case where a plurality of vehicles are going to enter an intersection at substantially the same time.

FIG. 9 is a conceptual diagram showing a risk in a case where the vehicle 500 autonomously travels at an intersection according to a control rule corresponding to a traffic regulation in a different region.

### DESCRIPTION OF EMBODIMENTS

Hereinafter, an embodiment of the present disclosure (hereinafter, referred to as “the present embodiment”) will be described in detail with reference to the drawings as appropriate. However, unnecessarily detailed descriptions may be omitted. For example, detailed description of a well-known matter or repeated description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims.

(Introduction to Present Disclosure)

JP-A-2017-061320 describes a self-driving vehicle that is switched to driving in an autonomous driving mode and observes a traffic regulation, when a vehicle traveling in a manual driving mode is about to violate the traffic regulation.

However, the traffic regulations such as the road traffic law to be followed by the vehicle are different for each region (country, state, prefecture, and the like). In consideration of a case where a vehicle moves across a plurality of regions by autonomous driving, the control itself of the autonomous driving needs to be performed according to different traffic regulations for each region. Here, the control of the autonomous driving includes control of route selection when passing through a roundabout intersection, a manner of a turn signal, a temporary stop before a railroad crossing, an entry into an intersection at a red or yellow light, and an order of driving priority when a plurality of vehicles arrive at an intersection substantially at the same time. If the autonomous driving control of the vehicle is performed according to traffic regulations in different regions, there is a risk that an unexpected accident occurs.

However, it has not been proposed so far to switch the control itself of the autonomous driving according to the change of the traffic regulation to be observed in a case where the vehicle crosses a border between regions having different traffic regulations while traveling by the autonomous driving.

Therefore, in the present disclosure, a control device of the vehicle performs control of appropriate autonomous driving corresponding to different traffic regulations for each region. Accordingly, even when the traveling vehicle moves by autonomous driving across a border between regions having different traffic regulations, it is possible to perform control of appropriate autonomous driving according to the traffic regulations of the respective regions, and it is possible to avoid the occurrence of the unexpected accident described above.

In the present disclosure, the autonomous driving includes not only driving assistance (fully autonomous driving) in which the vehicle controls steering and driving of the vehicle, but also driving assistance in which a user executes some control of steering, driving, and the like.

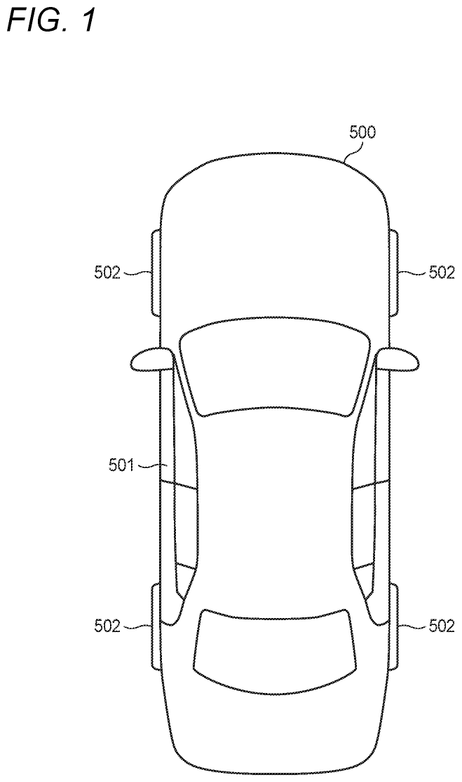

FIG. 1 is a top view conceptual diagram showing an example of a vehicle 500 on which autonomous driving control is performed by a control device. The vehicle 500 includes a vehicle body 501 and one or more wheels 502 coupled to the vehicle body 501. Typically, the vehicle 500 is a four-wheel automobile. The vehicle 500 may be a two-wheel motorcycle, an autonomous three-wheel motorcycle, and the like. That is, the vehicle 500 may be a vehicle other than four wheels. The vehicle 500 can travel in a predetermined direction using wheels. For the sake of convenience, the following description will be given on the assumption that the vehicle 500 is a four-wheel automobile.

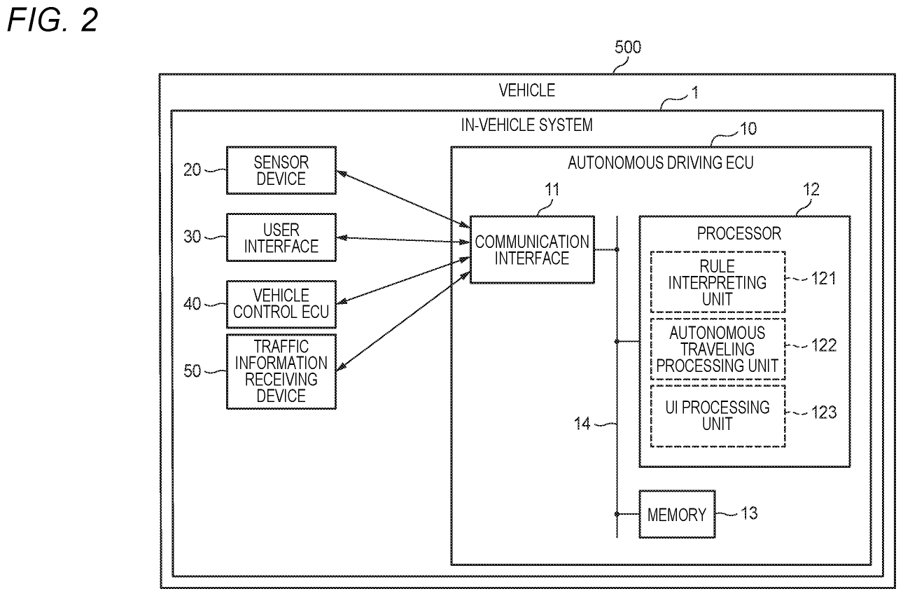

FIG. 2 is a block diagram showing a configuration example of the vehicle 500 including the control device of the present disclosure.

The vehicle 500 includes an in-vehicle system 1. The in-vehicle system 1 includes an autonomous driving ECU 10, a sensor device 20, a user interface 30, and a vehicle control ECU 40. The in-vehicle system 1 may further include a traffic information receiving device 50. As an example, the control device of the present disclosure may be the autonomous driving ECU 10. However, other devices may be interpreted as the control device. For example, the in-vehicle system 1 can be interpreted as one control device.

The sensor device 20 may include, for example, an imaging device, a distance sensor, and the like, but is not limited thereto. The sensor device 20 is a device that acquires various types of sensor information such as light, an image, sound, a radio wave, vibration, heat, GPS position information, and a beacon. The sensor device 20 may be implemented as a single device or may be implemented as a plurality of devices.

The user interface 30 is implemented by, for example, a touch panel type display device and the like. The user interface 30 has a function as an interface for inputting and outputting information between the user and the in-vehicle system 1, such as outputting information to the user (occupant) riding in the vehicle 500 and receiving information input from the user. When the user interface 30 is a touch panel type display device, information such as a map or a traveling route may be displayed on a display to present (output) the information to the user. Conversely, when the user touches a touch panel with a finger, the in-vehicle system 1 receives user input. Means for communicating information with the user is not limited to visual means, and the user interface 30 may include, for example, a speaker for outputting sound and a microphone for inputting sound. The user interface 30 is an example of notification means for notifying the occupant of the vehicle 500 of some kind of information.

The vehicle control ECU 40 controls in-vehicle devices included in the vehicle 500, such as a driving control device, a steering control device, a safety device, a battery, and a charger. The vehicle control ECU 40 is connected to the autonomous driving ECU 10 via a CAN and the like, and receives a command related to autonomous driving from the autonomous driving ECU 10. The vehicle control ECU 40 controls the above-described various in-vehicle devices under the control of the autonomous driving ECU 10.

The traffic information receiving device 50 is a device that receives traffic information such as traffic congestion and traffic regulations from the outside of the vehicle 500. The traffic information receiving device 50 may be, for example, an FM multiple antenna, an optical beacon antenna, a receiver of a radio beacon, and the like for receiving VICS (registered trademark). The traffic information receiving device 50 may receive information indicating a current position of the vehicle 500 (for example, information indicating a position where an optical beacon emitter is disposed) from the outside of the vehicle 500. The autonomous driving ECU 10 may acquire information indicating the current position of the vehicle 500 from the traffic information receiving device 50.

The autonomous driving ECU 10 includes a communication interface 11, a processor 12, and a memory 13. These components are connected to each other by a bus 14.

The processor 12 is implemented by using, for example, a central processing unit (CPU), a micro processing unit (MPU), a digital signal processor (DSP), or a field programmable gate array (FPGA), and performs various processing and control in cooperation with the memory 13. Specifically, the processor 12 implements functions of a rule interpreting unit 121, an autonomous traveling processing unit 122, and a UI processing unit 123 by referring to a program held in the memory 13 and executing the program. The processor 12 is an example of a control unit included in the control device.

The rule interpreting unit 121 acquires information (autonomous driving rule information) indicating a rule related to the autonomous driving of the vehicle 500, which will be described later, interprets the information, and transmits the interpreted control rule to the autonomous traveling processing unit 122 as control rule information. The rule interpreting unit 121 may acquire the autonomous driving rule information from the memory 13. Alternatively, the rule interpreting unit 121 may acquire the autonomous driving rule information from the user interface 30, an external device viewed from the vehicle 500, and the like via the communication interface 11. Here, since the traffic regulation may vary depending on regions such as countries, states, and prefectures, the autonomous driving rule information may be generated for each region such as countries, states, and prefectures, and the autonomous driving rule information may be respectively stored in the memory 13, the external device, and the like.

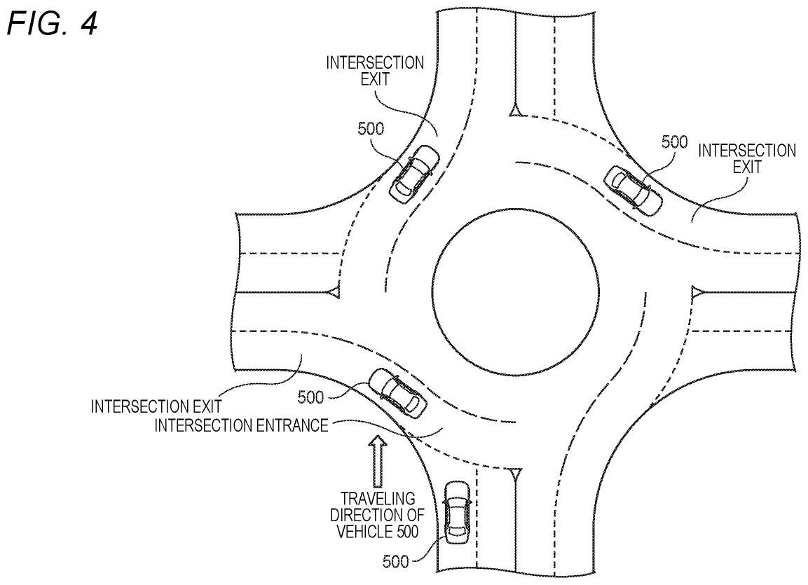

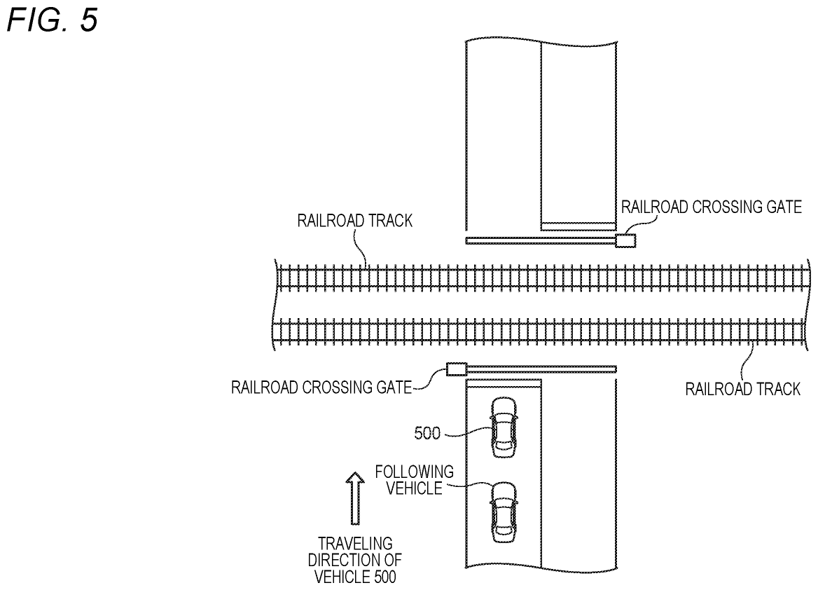

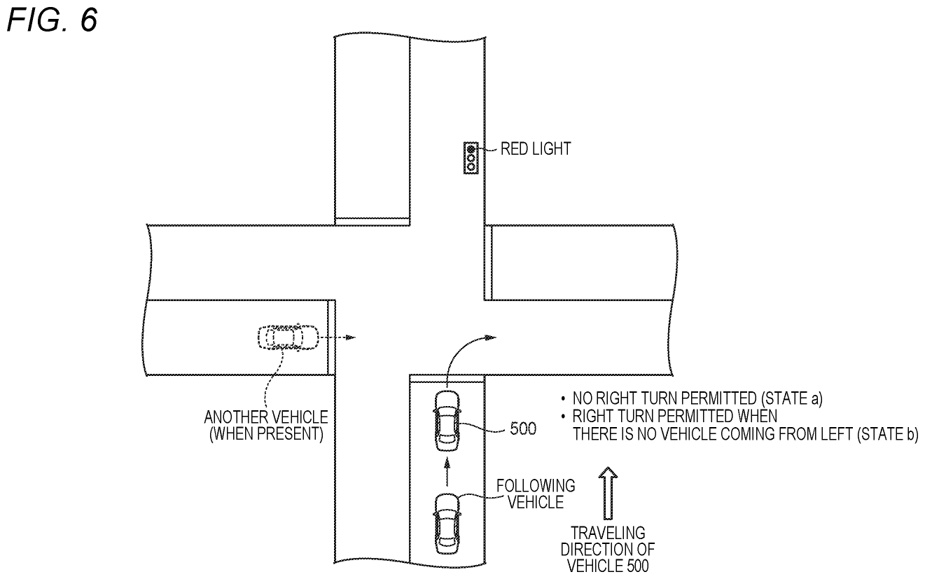

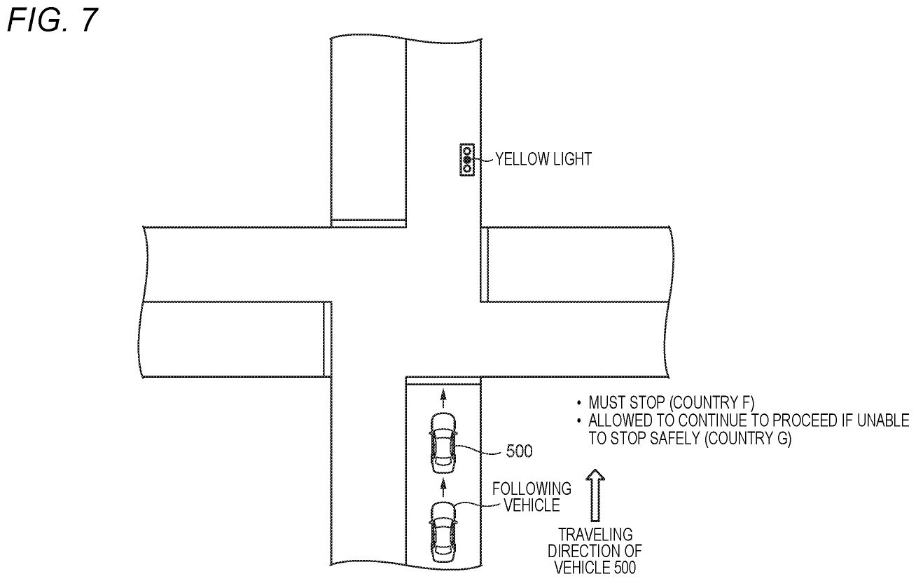

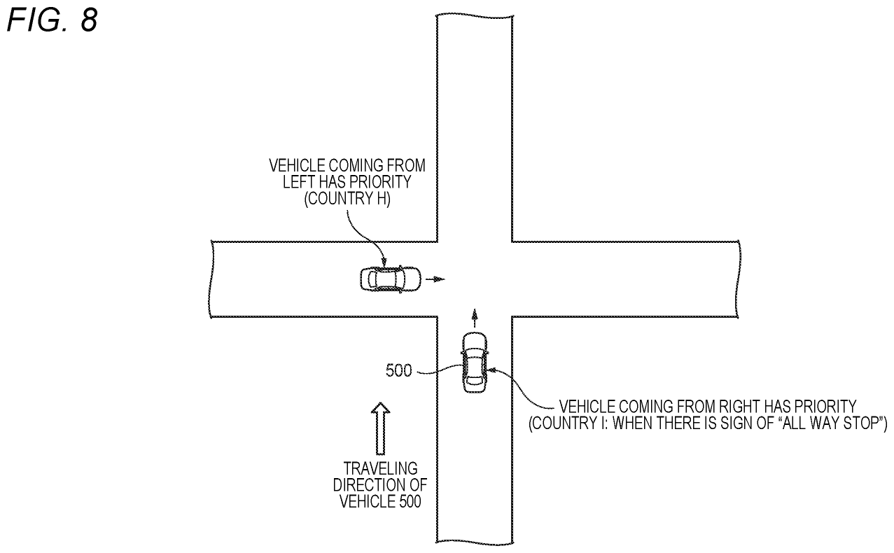

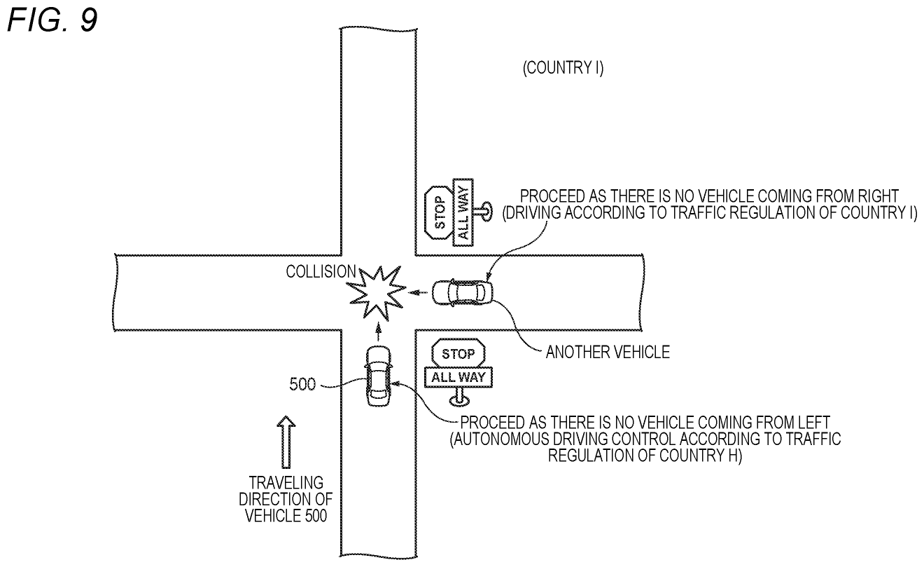

The control rule (control rule information) interpreted by the rule interpreting unit 121 includes, for example, a control rule (which will be described later based on FIG. 4) used when the vehicle 500 enters a roundabout intersection, a control rule (which will be described later based on FIG. 5) regarding a temporary stop of the vehicle 500 before a railroad crossing, a control rule (which will be described later based on FIG. 6) regarding the vehicle 500 turning right at a red light, a control rule (which will be described later based on FIG. 7) regarding the vehicle 500 passing through the intersection or stopping at the intersection at a yellow light, a control rule (which will be described later based on FIGS. 8 and 9) regarding a driving priority order when a plurality of vehicles enter the intersection at the same time, and the like. The control rule interpreted by the rule interpreting unit 121 is not limited to a specific example described above, and may include, for example, a control rule regarding whether the vehicle travels on the right side or the left side of a center line of a roadway, a control rule regarding identification of a vehicle (a school bus, an emergency vehicle, and the like) that should not be passed, a control rule regarding whether the vehicle can pass through a priority road according to the number of passengers (HOV: high occupancy vehicle), and the like. The autonomous driving rule information may be a bundle of these individual control rules, and the rule interpreting unit 121 extracts and interprets each control rule from the autonomous driving rule information, and transmits the interpreted control rule (control rule information) to the autonomous traveling processing unit 122.

The autonomous traveling processing unit 122 generates traveling route information of the vehicle 500. The autonomous traveling processing unit 122 acquires, for example, destination information received from the user interface 30, sensor information acquired by the sensor device 20, traffic information received by the traffic information receiving device 50, map information in the vicinity of the vehicle 500 stored in the memory 13 and the like, control rule information interpreted by the rule interpreting unit 121, and the like, and generates a traveling route related to autonomous driving based on these pieces of information.

The autonomous traveling processing unit 122 transmits a command to the vehicle control ECU 40 according to the generated traveling route, and controls autonomous traveling of the vehicle 500 along the traveling route. In the present specification, traveling by the autonomous driving of the vehicle is referred to as “autonomous traveling”. Autonomous traveling control by the autonomous traveling processing unit 122 may be performed based on feedback information and the like from the vehicle control ECU 40.

The autonomous traveling processing unit 122 can perform the autonomous traveling control of the vehicle 500 based on the sensor information acquired by the sensor device 20 during traveling of the vehicle 500. For example, when a pedestrian in front of the vehicle 500 is detected by a camera included in the sensor device 20, or when a collision of the vehicle 500 is detected by an impact sensor, an acceleration sensor, and the like included in the sensor device 20, the autonomous traveling processing unit 122 can transmit a command for causing the vehicle 500 to suddenly stop to the vehicle control ECU 40.

When the autonomous traveling processing unit 122 detects that congestion occurs on the current traveling route based on the traffic information received by the traffic information receiving device 50 during the autonomous traveling of the vehicle 500, the autonomous traveling processing unit 122 can generate a new traveling route and control the autonomous traveling along the new traveling route. The processing of generating the new traveling route by the autonomous traveling processing unit 122 may be executed with reference to map information in the vicinity of the current position of the vehicle 500 acquired from the memory 13 and the like, autonomous driving rule information additionally interpreted by the rule interpreting unit 121, and the like. The autonomous traveling processing unit 122 may transmit information indicating the above-described new traveling route to the UI processing unit 123, and notify the user (the occupant of the vehicle 500) of the change of the traveling route via the UI processing unit 123 and the user interface 30.

The UI processing unit 123 converts user input information received via the user interface 30 such that the autonomous traveling processing unit 122 can perform processing, and transmits the converted information to the autonomous traveling processing unit 122. Conversely, the UI processing unit 123 generates, based on the information received from the autonomous traveling processing unit 122, information to be presented to the user (the occupant of the vehicle 500), such as the above-described change notification of the traveling route, and transmits the information to the user interface 30.

The occupant of the vehicle 500, who is a user, can select either the new traveling route or an original traveling route via the user interface 30, and can change a final destination, add a via point, and the like. The autonomous traveling processing unit 122 that has acquired such user input via the user interface 30 may change the traveling route according to the information input by the user.

The memory 13 includes, for example, a random access memory (RAM) as a work memory used when each processing of the processor 12 is executed, and a read only memory (ROM) that stores a program and data defining an operation of the processor 12. Data or information generated or acquired by the processor 12 is temporarily stored in the RAM. The program that defines the operation of the processor 12 is written in the ROM. The memory 13 may store the above-described autonomous driving rule information, the map information in the vicinity of the vehicle 500, and the like.

The communication interface 11 has a function as an interface for inputting and outputting information between the in-vehicle systems 1 or between the in-vehicle system 1 and the outside of the in-vehicle system 1.

The above-described configuration of the in-vehicle system 1 is an example, and the in-vehicle system 1 may not necessarily include all of the above-described components. In addition, the in-vehicle system 1 may further include additional components.

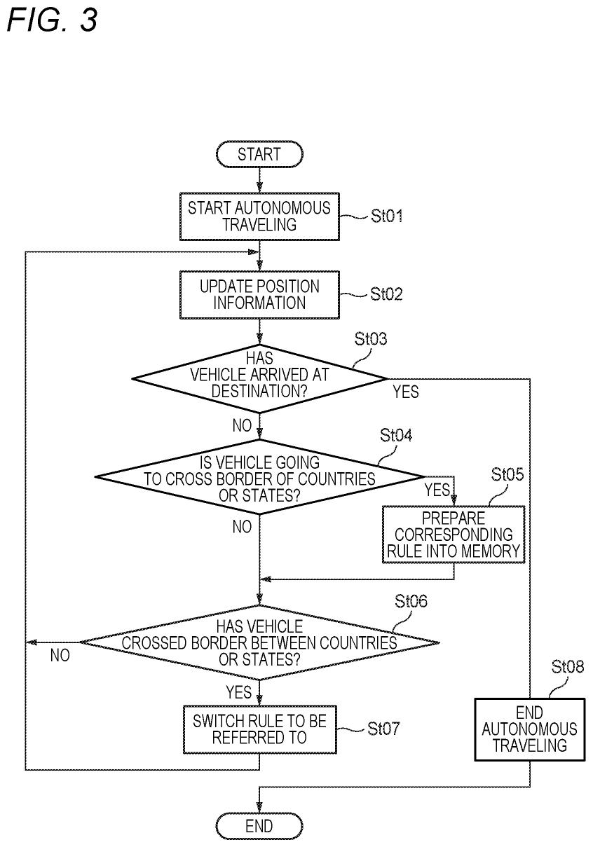

FIG. 3 is a flowchart showing an example of the autonomous driving control of the vehicle 500 by the control device of the present disclosure. For convenience, the description will be made on the assumption that the control device is the autonomous driving ECU 10 shown in FIG. 2 and the control unit included in the control device is the processor 12. However, the control device and the control unit are not intended to be limited to the autonomous driving ECU 10 and the processor 12. When the autonomous driving ECU 10 is the subject of the processing, the processing may be executed by the processor 12 which is the control unit.

In step St01, the autonomous traveling of the vehicle 500 is started. The start of the autonomous traveling may be triggered by user input (for example, the occupant of the vehicle 500 inputs a destination by a touch panel operation, a sound input, and the like). When the vehicle 500 is a connected car that moves under the control of the external device, the autonomous traveling may be started by inputting a command from the external device to the autonomous driving ECU 10. The autonomous driving ECU 10 acquires position information of the destination of the autonomous traveling from the sensor device 20 or the traffic information receiving device 50. Then, the autonomous traveling processing unit 122 performs the generation of the traveling route and the control of the autonomous traveling as described above.

Next, the autonomous driving ECU 10 updates the current position information of the vehicle 500 (step St02). More specifically, the autonomous traveling processing unit 122 acquires the current position information of the vehicle 500 from the sensor device 20, the traffic information receiving device 50, and the like.

Next, the autonomous driving ECU 10 determines whether the vehicle 500 has arrived at the destination (step St03). The determination can be performed by the autonomous traveling processing unit 122 comparing the position information of the destination acquired in step St01 with the current position information of the vehicle 500 acquired in step St02. When it is determined that the vehicle 500 has arrived at the destination (step St03: YES), the processing proceeds to step St08. When it is determined that the vehicle 500 has not arrived at the destination (step St03: NO), the processing proceeds to step St04.

In step St04, the autonomous driving ECU 10 determines whether the vehicle 500 is going to cross a border between regions having different traffic regulations. For example, the autonomous traveling processing unit 122 determines whether the vehicle 500 that is autonomously traveling is going to cross a border between a region X having a certain traffic regulation and a region Y having another traffic regulation. When the vehicle 500 is going to cross the border between the regions having different traffic regulations (step St04: YES), the processing proceeds to step St05. When the vehicle 500 does not cross the border between the regions having different traffic regulations (step St04: NO), the processing proceeds to step St06.

Here, the border between the regions having different traffic regulations may be determined for each unit of a local government such as a country, a state, and a prefecture, and information related to the border may be stored in an autonomous driving program executed by the autonomous traveling processing unit 122. In addition, the information related to the border may be recorded in the memory 13. The traffic regulations include, for example, different parts between Germany and French. That is, the traffic regulations may be different for each region. When the vehicle 500 that is autonomously traveling according to the traffic regulation of Germany crosses the border of countries from Germany to subsequent French during traveling, it is necessary to prepare the traffic regulation of French to be observed by the vehicle 500 after crossing the border of the countries. Therefore, for example, in step St04, the autonomous traveling processing unit 122 determines whether the vehicle 500 traveling in Germany approaches the border (national boundary) with French. In addition, even in the same country, traffic regulations may be different depending on states. In such a case, the autonomous traveling processing unit 122 determines whether the vehicle 500 traveling in a certain state approaches a border with another state having different traffic regulations in the same manner as described above.

The autonomous driving ECU 10 can execute, based on the current position information of the vehicle 500 acquired in step St02, the determination of whether the vehicle 500 is going to cross the border between the regions having different traffic regulations in step St04. More specifically, the autonomous traveling processing unit 122 can determine whether the vehicle 500 is going to cross the border between the regions having different traffic regulations (whether the vehicle 500 is approaching a border between countries, a border between states, and the like by a predetermined distance), based on the current position information described above, the map information acquired from the memory 13 and the like, and the traveling route generated by the autonomous traveling processing unit 122 in step St01.

In step St05, the autonomous driving ECU 10 acquires autonomous driving rule information corresponding to a traffic regulation of a region in which the vehicle 500 will travel from now (a region beyond the border described above). For example, when the vehicle 500 is going to travel from Germany to French across the border and is currently in the vicinity of the border on the French side, the autonomous driving ECU 10 acquires autonomous driving rule information corresponding to the traffic regulation of Germany, which is a region in which the vehicle 500 will travel from now (a region beyond the border described above). A format of the autonomous driving rule information is not limited, and may be, for example, a format in which condition determination corresponding to clauses in the traffic regulation is expressed in a structured form such as XML. In addition, the autonomous driving rule information may be expressed in a format such as a text format or a table format.

The autonomous driving rule information is stored in advance in the memory 13, and in step St05, the autonomous driving processing unit 122 may acquire the autonomous driving rule information by reading the autonomous driving rule information from the memory 13. In addition, the autonomous driving ECU 10 may communicate with an external server and the like via the communication interface 11, and acquire the autonomous driving rule information from the external server and the like. The acquired autonomous driving rule information is interpreted by the rule interpreting unit 121, and the control rule information corresponding to the autonomous driving rule information is read into the autonomous traveling processing unit 122. However, at this stage, switching of the control rule used by the autonomous traveling processing unit 122 is not performed.

In step St06, the autonomous driving ECU 10 determines whether the vehicle 500 crosses the border between the regions having different traffic regulations. For example, the autonomous traveling processing unit 122 determines whether the vehicle 500 traveling in the region X having a certain traffic regulation has entered the region Y having another traffic regulation. The autonomous traveling processing unit 122 can perform the determination based on the current position information of the vehicle 500 acquired in step St02, the map information acquired from the memory 13 and the like, and the traveling route generated by the autonomous traveling processing unit 122 in step St01. When the vehicle 500 crosses the border between the regions having different traffic regulations (step St06: YES), the processing proceeds to step St07. When the vehicle 500 does not cross the border between the regions having different traffic regulations (step St06: NO), the processing returns to step St02.

In step St07, the autonomous driving ECU 10 switches the control rule to be referred to. That is, since the vehicle 500 traveling in the region X having a certain traffic regulation has entered the region Y having another traffic regulation across the border, the control rule of the autonomous driving referred to by the autonomous traveling processing unit 122 is switched from the control rule corresponding to the traffic regulation of the region X to the control rule corresponding to the traffic regulation of the region Y. The processor 12 including the autonomous traveling processing unit 122 may transmit a control signal to the user interface 30 when the control rule is switched. The processor 12 notifies the occupant of the vehicle 500 by the control signal via the user interface 30 that the control content in the autonomous driving has been switched from a control content for the region X to a control content for the region Y.

After the control rule to be referred to is switched, the processing returns to step St02, and the autonomous traveling processing unit 122 controls the autonomous traveling of the vehicle 500 such that the vehicle 500 travels according to the traffic regulation of the region Y.

In step St08, since the vehicle 500 has arrived at the destination, the autonomous traveling of the vehicle 500 ends. That is, the control of the vehicle control ECU 40 and the like by the autonomous traveling processing unit 122 ends.

By the autonomous driving ECU 10 performing the autonomous driving control as described above, even when the vehicle 500 travels across the border between the regions (countries, states, prefectures, and the like) having different traffic regulations, the vehicle 500 can autonomously travel according to the traffic regulations of the respective regions.

FIG. 4 is a conceptual diagram showing a traffic regulation for a roundabout intersection. In a country A, it is defined by a traffic regulation that, when the vehicle 500 enters the roundabout intersection, the selection of a traveling lane and a turn signal operation are to be performed as follows.

<Traffic Regulation for Roundabout Intersection in Country A>
In any case of going straight, turning left, or turning right at an intersection: Go slow along a (left) side edge of the intersection.
In any case of going straight, turning left, or turning right at the intersection: Turn on the left-turn signal before exiting the intersection (the turn signal not required to be turned on when arriving at the intersection).

The autonomous traveling processing unit 122 of the vehicle 500 traveling in the country A controls the autonomous traveling of the vehicle 500 according to a control rule corresponding to a traffic regulation for roundabout intersection traveling in the country A. For example, the autonomous traveling processing unit 122 controls the autonomous driving of the vehicle 500 with reference to the following control rules.
When the vehicle 500 approaches a position at a predetermined first distance from an entrance of the roundabout intersection, the vehicle control ECU 40 is controlled to decelerate the vehicle 500 to a predetermined speed corresponding to slow down.
When the vehicle 500 approaches a position at a predetermined second distance (first distance>second distance) from the entrance of the roundabout intersection, the vehicle control ECU 40 is controlled such that the vehicle 500 approaches the side edge of the intersection.
When the vehicle 500 approaches a position at a predetermined third distance from an exit of the roundabout intersection, the vehicle control ECU 40 is controlled to turn on the left-turn signal.

The above-described control rules having the autonomous traveling processing unit 122 as a processing subject are merely examples, and the autonomous traveling processing unit 122 may control the autonomous driving of the vehicle 500 with reference to other control rules.

The autonomous traveling processing unit 122 controls the autonomous driving of the vehicle 500 according to the control rule corresponding to the traffic regulation for the roundabout intersection in the country A, and therefore, the vehicle 500 can correctly travel through the roundabout intersection according to the traffic regulation of the country A.

On the other hand, in a country B, it is defined by a traffic regulation that, when the vehicle 500 enters the roundabout intersection, the selection of a traveling lane and a turn signal operation are to be performed as follows.

<Traffic Regulation for Roundabout Intersection in Country B>
In case where the vehicle goes straight at the intersection: May drive in any of the right lane or the left lane unless there is no road surface sign that gives another instruction, but drive in the same lane in the roundabout intersection and exit into the same lane at the exit of the intersection; do not turn on the turn signal until the vehicle arrives at the intersection; and continue to turn on the left-turn signal until the vehicle exits from the intersection.
In case where the vehicle turns left at the intersection: Turning on the left-turn signal when arriving at the intersection and drive in the left lane.
In case where the vehicle turns right at the intersection: Turn on the right-turn signal when arriving at the intersection and drive in the right lane; and keep driving in the right lane, and turn on the left-turn signal before exiting into the right lane at the exit of the intersection.

Here, a case is considered in which the vehicle 500 autonomously traveling in the country A enters the country B across the border. When the switching of the above-described control rule according to the present application (step St07) is not performed, the autonomous traveling processing unit 122 of the vehicle 500 controls the autonomous traveling of the vehicle 500 in the country B according to the control rule corresponding to the traffic regulation for the roundabout intersection in the country A. Then, even when the vehicle 500 turns right at the roundabout intersection in country B, the vehicle 500 travels in the left lane and turns on the left-turn signal. At this time, the driver of the following vehicle traveling immediately behind the vehicle 500 erroneously recognizes that the vehicle 500 in front should not turn right because the vehicle 500 in front is not near the right lane and the right-turn signal is not turned on. This erroneous recognition may cause an unexpected accident such as a collision between vehicles.

In order to avoid such a situation and perform safe autonomous traveling, when the vehicle 500 crosses the border from the country A to the country B, the autonomous traveling processing unit 122 switches the control rule to be referred to from the control rule for the country A to the control rule for the country B (step St07). The autonomous traveling processing unit 122 of the vehicle 500 after switching the control rule controls the autonomous traveling of the vehicle 500 according to the control rule corresponding to the traffic regulation for the roundabout intersection in the B country. For example, the autonomous traveling processing unit 122 controls the autonomous driving of the vehicle 500 with reference to the following control rules.
Based on the generated (step St01) traveling route, it is determined whether the vehicle 500 is turning right, turning left, or traveling straight (the traveling direction of the vehicle 500).
It is determined whether there is a plurality of lanes in the traveling direction by analyzing image information acquired from the camera included in the sensor device.
It is determined whether there is a road surface sign for giving an instruction, such as that the vehicle is to travel on a specific lane among the plurality of lanes in the vicinity before the intersection, by analyzing the image information acquired from the camera included in the sensor device.
According to the presence or absence of the road surface sign and whether the vehicle 500 is turning right, turning left, or traveling straight (the traveling direction of the vehicle 500), it is determined which lane among the plurality of lanes is to travel (the right lane or the left lane), and lane change control of the vehicle 500 is performed as necessary.
When the vehicle 500 turns left or travels straight at the intersection, the left-turn signal is turned on in the vicinity of the intersection entrance. When the vehicle 500 turns right at the intersection, the right-turn signal is turned on when the vehicle 500 enters the intersection, and then the right-turn signal is turned off and the left-turn signal is turned on after the vehicle 500 enters the intersection.

The above-described control rules having the autonomous traveling processing unit 122 as a processing subject are merely examples, and the autonomous traveling processing unit 122 may control the autonomous driving of the vehicle 500 with reference to other control rules.

After switching the control rule to be referred to, the autonomous traveling processing unit 122 in the vehicle 500 controls the traveling lane selection (and, if necessary, lane change) according to each traveling direction, and controls the turn signal lighting processing, according to the traffic regulation of the country B. As a result, the vehicle 500 can correctly travel through the roundabout intersection according to the traffic regulation of the country B, and can avoid an unexpected accident due to the above-described erroneous recognition and perform safe autonomous traveling.

The above shows an example of switching of the control rule referred to by the autonomous traveling processing unit 122 when the vehicle 500 autonomously traveling in the country A enters the country B across the border. On the other hand, when the vehicle 500 autonomously traveling in the country B enters the country A across the border, the control rule referred to by the autonomous traveling processing unit 122 may be similarly switched (step St07). When the vehicle 500 autonomously traveling in the country B enters the country A across the border, if the switching of the above-described control rule according to the present application (step St07) is not performed, the autonomous traveling processing unit 122 of the vehicle 500 controls the autonomous traveling of the vehicle 500 in the country A according to the control rule corresponding to the traffic regulation for the roundabout intersection in the country B. Then, even when the vehicle 500 turns right at the roundabout intersection in the country A, the vehicle 500 travels in the roundabout intersection while keeping the turn signal on. At this time, the driver of the following vehicle traveling immediately behind the vehicle 500 erroneously recognizes that the vehicle 500 in front should turn left at the roundabout intersection because the turn signal of the vehicle 500 in front is turned on. This erroneous recognition may cause an unexpected accident such as a collision between vehicles. Actually, when there is a sidewalk at the exit of the roundabout intersection in the left turn direction and a pedestrian is present on the sidewalk, the driver of the following vehicle considers that the vehicle 500 will stop, and the following vehicle decelerates. Then, there is a possibility that the following vehicle collides with a vehicle further behind the following vehicle.

FIG. 5 is a conceptual diagram showing a traffic regulation for a temporary stop before a railroad crossing. In a country C, it is defined by the traffic regulation that when the vehicle 500 enters a railroad crossing, the operation of the vehicle is to be performed as follows.

<Traffic Regulation for Temporary Stop Before Railroad Crossing in Country C>
In case where the vehicle is going to pass through the railroad crossing: Stop immediately before the railroad crossing (immediately before the stop line when the stop line such as a road sign is provided), and do not proceed unless confirming that it is safe.

The autonomous traveling processing unit 122 of the vehicle 500 traveling in the country C controls the autonomous traveling of the vehicle 500 according to a control rule corresponding to a traffic regulation for a temporary stop before a railroad crossing in the country C. For example, the autonomous traveling processing unit 122 controls the autonomous driving of the vehicle 500 with reference to the following control rules.
The presence of a railroad crossing in the traveling direction of the vehicle 500 is detected. This detection may be executed based on an image captured by the camera included in the sensor device 20, map information, GPS position information, and the like.
It is determined whether a white line indicating a stop line is drawn before the detected railroad crossing, by controlling the camera included in the sensor device 20 and recognizing the image.
When a white line indicating a stop line is drawn before the railroad crossing, the vehicle control ECU 40 is controlled to decelerate the vehicle 500 and stop the vehicle 500 before the white line.
When a white line indicating a stop line is not drawn before the railroad crossing, the vehicle control ECU 40 is controlled to decelerate the vehicle 500 and stop the vehicle 500 at a position just before a predetermined distance from the railroad crossing.
After the vehicle 500 is stopped, the stopped state of the vehicle 500 is maintained for a predetermined number of seconds.
It is determined whether the vehicle 500 can safely pass through the railroad crossing. This determination may be performed by the autonomous traveling processing unit 122 controlling the camera included in the sensor device 20 and recognizing an image. The autonomous traveling processing unit 122 may detect, for example, a state of a railroad crossing gate (a lighting state of a lamp included in the railroad crossing gate, a state of a horizontal bar lowered by the railroad crossing gate, and the like), a position of another vehicle, a pedestrian, a bicycle, and the like present in the vicinity of the railroad crossing, whether a train has passed through a railroad track, and the like by the image recognition from the captured image of the camera, and perform the above-described determination based on these pieces of information. In addition, the autonomous traveling processing unit 122 may acquire sound around the vehicle 500 using the microphone included in the sensor device 20, detect sound corresponding to the approach of the train, and perform the above-described determination based on the sound information.
The above-described determination as to whether the vehicle 500 can safely pass through a railroad crossing is performed many times at predetermined time intervals. When it is determined that the vehicle 500 can safely pass through the railroad crossing, the vehicle control ECU 40 is controlled to accelerate and advance the vehicle 500, and the vehicle 500 passes through the railroad crossing.

The above-described control rules having the autonomous traveling processing unit 122 as a processing subject are merely examples, and the autonomous traveling processing unit 122 may control the autonomous driving of the vehicle 500 with reference to other control rules.

The autonomous traveling processing unit 122 controls the autonomous driving of the vehicle 500 according to the control rule corresponding to the traffic regulation for the temporary stop before the railroad crossing in the country C, and therefore, the vehicle 500 can pass through the railroad crossing after correctly performing the temporary stop before the railroad crossing according to the traffic regulation of the country C.

On the other hand, in a country D, it is defined by the traffic regulation that when the vehicle 500 enters a railroad crossing, the operation of the vehicle is to be performed as follows.

<Traffic Regulation for Temporary Stop Before Railroad Crossing in Country D>
In case where the vehicle is going to pass through a railroad crossing: Stop when a railroad crossing gate is closed.
In case where the railroad crossing gate is not closed: May proceed without decelerate or temporarily stop.

Here, a case is considered in which the vehicle 500 autonomously traveling in the country C enters the country D across the border. When the switching of the above-described control rule according to the present application (step St07) is not performed, the autonomous traveling processing unit 122 of the vehicle 500 controls the autonomous traveling of the vehicle 500 in the country D according to the control rule corresponding to the traffic regulation for the temporary stop before the railroad crossing in the country C. Then, when the railroad crossing gate is not closed, the vehicle 500 temporarily stops before the railroad crossing in the country D. At this time, the driver of the following vehicle traveling immediately behind the vehicle 500 erroneously recognizes that the vehicle 500 will travel straight without decelerating or temporarily stopping. This erroneous recognition may cause an unexpected accident such as a collision between vehicles.

In order to avoid such a situation and perform safe autonomous traveling, when the vehicle 500 crosses a country from the country C to the country D, the autonomous traveling processing unit 122 switches the control rule to be referred to from the control rule for the country C to the control rule for the country D (step St07). The autonomous traveling processing unit 122 of the vehicle 500 after switching the control rule controls the autonomous traveling of the vehicle 500 according to a control rule corresponding to a traffic regulation for a temporary stop before a railroad crossing in the country D. For example, the autonomous traveling processing unit 122 controls the autonomous driving of the vehicle 500 with reference to the following control rules.
The presence of a railroad crossing in the traveling direction of the vehicle 500 is detected. This detection may be executed based on an image captured by the camera included in the sensor device 20, map information, GPS position information, and the like.
In the detected railroad crossing, it is determined whether a railroad crossing gate is closed, by controlling the camera included in the sensor device 20 and recognizing an image.
When the railroad crossing gate is not closed, the vehicle control ECU 40 is controlled such that the vehicle 500 passes through the railroad crossing at the same speed.
When the railroad crossing gate is closed, the vehicle control ECU 40 is controlled to decelerate the vehicle 500 and stop the vehicle 500 at a position just before a predetermined distance from the railroad crossing.
In the detected railroad crossing, it is determined whether the railroad crossing gate has opened, by controlling the camera included in the sensor device 20 and recognizing an image.
The above-described determination as to whether the railroad crossing gate has opened is performed many times at predetermined time intervals. When it is determined that the railroad crossing gate has opened, the vehicle control ECU 40 is controlled to accelerate and advance the vehicle 500, and the vehicle 500 passes through the railroad crossing.

The above-described control rules having the autonomous traveling processing unit 122 as a processing subject are merely examples, and the autonomous traveling processing unit 122 may control the autonomous driving of the vehicle 500 with reference to other control rules.

After switching the control rule to be referred to, the autonomous traveling processing unit 122 in the vehicle 500 controls traveling, a temporary stop, re-acceleration, and the like of the vehicle 500 according to the traffic regulation of the country D. As a result, the vehicle 500 can pass through a railroad crossing correctly according to the traffic regulation of the country D, and can avoid an unexpected accident due to the above-described erroneous recognition and perform safe autonomous traveling.

The above shows an example of switching of the control rule referred to by the autonomous traveling processing unit 122 when the vehicle 500 autonomously traveling in the country C enters the country D across the border. On the other hand, when the vehicle 500 autonomously traveling in the country D enters the country C across the border, the control rule referred to by the autonomous traveling processing unit 122 may be similarly switched (step St07).

FIG. 6 is a conceptual diagram showing a traffic regulation for a temporary stop at a red light in a country E. In a state a in the country E, it is defined by the traffic regulation that when the vehicle 500 enters an intersection, the operation of the vehicle is to be performed as follows.

<Traffic Regulation for Temporary Stop at Red Light in State a in Country E>
A red light in a traffic light: Do not proceed beyond a stop position.

The autonomous traveling processing unit 122 of the vehicle 500 traveling in the state a of the country E controls the autonomous traveling of the vehicle 500 according to a control rule corresponding to a traffic regulation for a temporary stop at a red light in the state a of the country E. For example, the autonomous traveling processing unit 122 controls the autonomous driving of the vehicle 500 with reference to the following control rules.
The presence of a traffic light in the traveling direction of the vehicle 500 is detected. This detection may be executed based on an image captured by the camera included in the sensor device 20.
A color of the light of the detected traffic light is determined based on the image captured by the camera. In a case of a red light, the vehicle control ECU 40 is controlled to decelerate the vehicle 500 and stop the vehicle 500 before the stop position.
After the vehicle 500 stops, it is determined whether the color of the light of the detected traffic light has changed to green (green light). This determination may be executed based on an image captured by the camera included in the sensor device 20.
The above-described determination as to whether the color of the light of the detected traffic light has changed to green (green light) is performed many times at predetermined time intervals. When it is determined that the color of the light of the traffic light has changed to green (green light), the vehicle control ECU 40 is controlled to accelerate and advance the vehicle 500, and the vehicle 500 passes through the intersection.

The above-described control rules having the autonomous traveling processing unit 122 as a processing subject are merely examples, and the autonomous traveling processing unit 122 may control the autonomous driving of the vehicle 500 with reference to other control rules.

The autonomous traveling processing unit 122 controls the autonomous driving of the vehicle 500 according to the control rule corresponding to the traffic regulation for the temporary stop at the red light in the state a of the country E, and therefore, the vehicle 500 can pass through the intersection at the green light after correctly performing the temporary stop before the intersection according to the traffic regulation of the country E.

On the other hand, in a state b in the country E, it is defined by the traffic regulation that when the vehicle 500 enters an intersection, the operation of the vehicle is to be performed as follows.

<Traffic Regulation for Temporary Stop at Red Light in State b in Country E>
A red light in a traffic light: Temporarily stop before a stop position; then may enter the intersection and turn to the right at the red light after confirming that a vehicle does not come from the left.

Here, a case is considered in which the vehicle 500 autonomously traveling in the state a of the country E enters the state b across the border between the states. When the switching of the above-described control rule according to the present application (step St07) is not performed, the autonomous traveling processing unit 122 of the vehicle 500 controls the autonomous traveling of the vehicle 500 in the state b according to the control rule corresponding to the traffic regulation for the temporary stop at the red light in the state a. Then, when the front traffic light is a red light, the vehicle 500 that is going to turn right temporarily stops before the stop position, and continues to stop until the traffic light becomes a green light. At this time, when another vehicle does not come from the left, the driver of the following vehicle traveling immediately behind the vehicle 500 erroneously recognizes that the vehicle 500 will start to turn right even at the red light. This erroneous recognition may cause an unexpected accident such as a collision between the vehicles.

In order to avoid such a situation and perform safe autonomous traveling, when the vehicle 500 crosses the border between the states from the state a to the state b in the country E, the autonomous traveling processing unit 122 switches the control rule to be referred to from the control rule for the state a to the control rule for the state b (step St07). The autonomous traveling processing unit 122 of the vehicle 500 after switching the control rule controls the autonomous traveling of the vehicle 500 according to a control rule corresponding to a traffic regulation for a temporary stop at a red light in the state b. For example, the autonomous traveling processing unit 122 controls the autonomous driving of the vehicle 500 with reference to the following control rules.
The presence of a traffic light in the traveling direction of the vehicle 500 is detected. This detection may be executed based on an image captured by the camera included in the sensor device 20.
A color of the light of the detected traffic light is determined based on the image captured by the camera. In a case of a red light, the vehicle control ECU 40 is controlled to decelerate the vehicle 500 and stop the vehicle 500 before the stop position.
After the vehicle 500 stops, it is determined whether there is another vehicle that is going to enter the intersection from the left of the intersection. This determination may be executed based on an image captured by the camera included in the sensor device 20.
The above-described determination as to whether there is another vehicle that is going to enter the intersection from the left of the intersection is performed many times at predetermined time intervals. When it is determined that there is no other vehicle, the vehicle control ECU 40 is controlled to accelerate and advance the vehicle 500, and the vehicle 500 turns right at the intersection and passes through the intersection.

The above-described control rules having the autonomous traveling processing unit 122 as a processing subject are merely examples, and the autonomous traveling processing unit 122 may control the autonomous driving of the vehicle 500 with reference to other control rules.

After switching the control rule to be referred to, the autonomous traveling processing unit 122 in the vehicle 500 controls traveling, a temporary stop, right steering, re-acceleration, and the like of the vehicle 500 according to the traffic regulation of the state b in the country E. As a result, the vehicle 500 can correctly turn right and pass through the intersection according to the traffic regulation of the state b in the country E, and can avoid an unexpected accident due to the above-described erroneous recognition and perform safe autonomous traveling.

The above shows an example of switching of the control rule referred to by the autonomous traveling processing unit 122 when the vehicle 500 autonomously traveling in the state a of the country E enters the state b of the country E across the border. On the other hand, when the vehicle 500 autonomously traveling in the state b of the country E enters the state a of the country E across the border, the control rule referred to by the autonomous traveling processing unit 122 may be similarly switched (step St07).

FIG. 7 is a conceptual diagram showing a traffic regulation for a temporary stop at a yellow light. In a country F, it is defined by the traffic regulation that when the vehicle 500 enters an intersection, the operation of the vehicle is to be performed as follows.

<Traffic Regulation for Temporary Stop at Yellow Light in Country F>
A yellow light in a traffic light: Do not proceed beyond a stop position.

The autonomous traveling processing unit 122 of the vehicle 500 autonomously traveling in the country F controls the autonomous traveling of the vehicle 500 according to a control rule corresponding to a traffic regulation for a temporary stop at a yellow light in the country F. For example, the autonomous traveling processing unit 122 controls the autonomous driving of the vehicle 500 with reference to the following control rules.
The presence of a traffic light in the traveling direction of the vehicle 500 is detected. This detection may be executed based on an image captured by the camera included in the sensor device 20.
A color of the light of the detected traffic light is determined based on the image captured by the camera. In a case of a yellow light, the vehicle control ECU 40 is controlled to decelerate the vehicle 500 and stop the vehicle 500 before the stop position.
After the vehicle 500 stops, it is determined whether the color of the light of the detected traffic light has changed to green (green light). This determination may be executed based on an image captured by the camera included in the sensor device 20.
The above-described determination as to whether the color of the light of the detected traffic light has changed to green (green light) is performed many times at predetermined time intervals. When it is determined that the color of the light of the traffic light has changed to green (green light), the vehicle control ECU 40 is controlled to accelerate and advance the vehicle 500, and the vehicle 500 passes through the intersection.

The above-described control rules having the autonomous traveling processing unit 122 as a processing subject are merely examples, and the autonomous traveling processing unit 122 may control the autonomous driving of the vehicle 500 with reference to other control rules.

The autonomous traveling processing unit 122 controls the autonomous driving of the vehicle 500 according to the control rule corresponding to the traffic regulation for the temporary stop at the yellow light in the country F, and therefore, the vehicle 500 can pass through the intersection at the green light after correctly performing the stop before the intersection according to the traffic regulation of the country F.

On the other hand, in a country G, it is defined by the traffic regulation that when the vehicle 500 enters an intersection, the operation of the vehicle is to be performed as follows.

<Traffic Regulation for Temporary Stop at Yellow Light in Country G>
A yellow light in a traffic light: Do not proceed beyond a stop position unless the vehicle is not able to stop safely because the vehicle is close to the stop position when the signal of the yellow light is indicated.

Here, a case is considered in which the vehicle 500 autonomously traveling in the country F enters the country G across the border between the states. When the switching of the above-described control rule according to the present application (step St07) is not performed, the autonomous traveling processing unit 122 of the vehicle 500 controls the autonomous traveling of the vehicle 500 in the country G according to the control rule corresponding to the traffic regulation for the temporary stop at the yellow light in the country F. Then, when the front traffic light is a yellow light, even when the vehicle 500 travels at a high speed, the vehicle 500 temporarily stops at the stop position, and continues to stop until the traffic light becomes a green light. At this time, the driver of the following vehicle traveling immediately behind the vehicle 500 erroneously recognizes that, the vehicle 500 cannot safely stop because the vehicle 500 has a high speed and is close to the stop position, and the following vehicle may similarly enter the intersection. As a result, an unexpected accident such as a collision between vehicles may occur.

In order to avoid such a situation and perform safe autonomous traveling, when the vehicle 500 crosses the border from the country F to the country G, the autonomous traveling processing unit 122 switches the control rule to be referred to from the control rule for the country F to the control rule for the country G (step St07). The autonomous traveling processing unit 122 of the vehicle 500 after switching the control rule controls the autonomous traveling of the vehicle 500 according to a control rule corresponding to a traffic regulation for a temporary stop at a yellow light in the country G. For example, the autonomous traveling processing unit 122 controls the autonomous driving of the vehicle 500 with reference to the following control rules.
The presence of a traffic light in the traveling direction of the vehicle 500 is detected. This detection may be executed based on an image captured by the camera included in the sensor device 20.
A color of the light of the detected traffic light is determined based on the image captured by the camera. In a case of a yellow light, a stop line indicating a stop position is detected. This detection may be executed based on an image captured by the camera included in the sensor device 20.
A distance from a current position of the vehicle 500 to the detected stop line is calculated. As the current position of the vehicle 500, GPS position information acquired from a GPS receiver included in the sensor device 20 may be used.
A current traveling speed of the vehicle 500 is acquired as feedback information from the vehicle control ECU 40.
It is determined whether the vehicle 500 can safely stop at the stop position, based on the distance from the current position of the vehicle 500 to the stop line and the current traveling speed of the vehicle 500.
When it is determined that the vehicle 500 cannot safely stop at the stop position, the vehicle control ECU 40 is controlled to advance the vehicle 500, and the vehicle 500 passes through the intersection.
When it is determined that the vehicle 500 can safely stop at the stop position, the vehicle control ECU 40 is controlled to decelerate the vehicle 500 and stop the vehicle 500 before the stop line.
After the vehicle 500 stops, it is determined whether the color of the light of the detected traffic light has changed to green (green light). This determination may be executed based on an image captured by the camera included in the sensor device 20.
The above-described determination as to whether the color of the light of the detected traffic light has changed to green (green light) is performed many times at predetermined time intervals. When it is determined that the color of the light of the traffic light has changed to green (green light), the vehicle control ECU 40 is controlled to accelerate and advance the vehicle 500, and the vehicle 500 passes through the intersection.

The above-described control rules having the autonomous traveling processing unit 122 as a processing subject are merely examples, and the autonomous traveling processing unit 122 may control the autonomous driving of the vehicle 500 with reference to other control rules.

After switching the control rule to be referred to, the autonomous traveling processing unit 122 in the vehicle 500 controls traveling, a temporary stop, re-acceleration, and the like of the vehicle 500 according to the traffic regulation of the country G. As a result, the vehicle 500 can pass through the intersection while correctly dealing with the yellow light according to the traffic regulation of the country G. In addition, the vehicle 500 can avoid an unexpected accident due to the above-described erroneous recognition and perform safe autonomous traveling.

The above shows an example of switching of the control rule referred to by the autonomous traveling processing unit 122 when the vehicle 500 autonomously traveling in the country F enters the country G across the border. On the other hand, when the vehicle 500 autonomously traveling in the country G enters the country F across the border, the control rule referred to by the autonomous traveling processing unit 122 may be similarly switched (step St07).

FIG. 8 is a conceptual diagram showing a traffic regulation for a driving priority order in a case where a plurality of vehicles are going to enter an intersection at substantially the same time. In a country H, it is defined by the traffic regulation that when the vehicle 500 enters an intersection, the operation of the vehicle is to be performed as follows.

<Traffic Regulation for Driving Priority Order in a Case where a Plurality of Vehicles are Going to Enter Intersection at Substantially the Same Time in Country H>
At an uncontrolled intersection: Do not obstruct traveling of a vehicle coming from the left on a road (intersection road) intersecting with a road on which the vehicle is traveling, except for a case where there is a priority road.

The autonomous traveling processing unit 122 of the vehicle 500 traveling in the country H controls the autonomous traveling of the vehicle 500 according to a control rule corresponding to a traffic regulation for a driving priority order in a case where a plurality of vehicles are going to enter an intersection at substantially the same time in the country H. For example, the autonomous traveling processing unit 122 controls the autonomous driving of the vehicle 500 with reference to the following control rules.
The presence of an intersection in the traveling direction of the vehicle 500 is detected. This detection may be executed based on an image captured by the camera included in the sensor device 20, map information, GPS position information, and the like.
It is determined whether the detected intersection is an uncontrolled intersection with no priority road. This determination may be executed based on road sign information of the intersection associated with the map information or road sign information acquired by image recognition of a road sign shown in the image captured by the camera included in the sensor device 20. The determination may be executed further based on whether a person who holds a fluorescent rod and the like and performs traffic control is shown in the image captured by the camera included in the sensor device 20.
It is determined whether there is a vehicle traveling on the intersection road from the left. This determination may be executed based on an image captured by the camera included in the sensor device 20.
When it is determined that there is no vehicle traveling on the intersection road from the left, the vehicle control ECU 40 is controlled to advance the vehicle 500, and the vehicle 500 passes through the intersection.
When it is determined that there is a vehicle traveling on the intersection road from the left, the vehicle control ECU 40 is controlled to decelerate the vehicle 500 and stop the vehicle 500.
After the vehicle 500 stops, it is determined whether there is no vehicle traveling on the intersection road from the left (whether the vehicle traveling from the left has already passed through the intersection). This determination may be executed based on an image captured by the camera included in the sensor device 20.
The above-described determination as to whether there is no vehicle traveling on the intersection road from the left is performed many times at predetermined time intervals. When it is determined that there is no vehicle traveling on the intersection road from the left, the vehicle control ECU 40 is controlled to accelerate and advance the vehicle 500, and the vehicle 500 passes through the intersection.

The above-described control rules having the autonomous traveling processing unit 122 as a processing subject are merely examples, and the autonomous traveling processing unit 122 may control the autonomous driving of the vehicle 500 with reference to other control rules.

The autonomous traveling processing unit 122 controls the autonomous driving of the vehicle 500 according to a control rule corresponding to a traffic regulation for a driving priority order in a case where a plurality of vehicles are going to enter an intersection at substantially the same time in the country H, and therefore, the vehicle 500 can correctly pass through the intersection according to the traffic regulation in the country H.

On the other hand, in a country I, it is defined by the traffic regulation that when the vehicle 500 enters the intersection, the operation of the vehicle is to be performed as follows.

<Traffic Regulation for Driving Priority Order in a Case where a Plurality of Vehicles are Going to Enter Intersection at Substantially the Same Time in Country I>
Temporarily stop at an intersection where there is a sign described as “ALL WAY STOP” or “4 WAY STOP” and pass through the intersection in an order of arrival at the intersection. However, when there are other vehicles that have arrived at the intersection substantially at the same time, the vehicle on the right has priority.

FIG. 9 is a conceptual diagram showing a risk in a case where the vehicle 500 autonomously travels at an intersection according to a control rule corresponding to a traffic regulation in a different region.

Here, a case is considered in which the vehicle 500 autonomously traveling in the country H enters the country I across the border. When the switching of the above-described control rule according to the present application (step St07) is not performed, the autonomous traveling processing unit 122 of the vehicle 500 controls the autonomous traveling of the vehicle 500 in the country I according to the control rule corresponding to the traffic regulation for the intersection in the country H. Then, when the vehicle that has arrived at the intersection substantially at the same time is not present on the left of the vehicle 500 (in a case of a state shown in FIG. 9), the vehicle 500 starts to enter the intersection. On the other hand, when another vehicle that has arrived at the intersection at substantially the same time as the vehicle 500 is present on the right of the vehicle 500 (in a case of a state shown in FIG. 9), the another vehicle can preferentially enter the intersection in the country I, and thus the another vehicle also starts to enter the intersection. As a result, an unexpected accident such as a collision between the vehicle 500 and another vehicle at an intersection may occur.

In order to avoid such a situation and perform safe autonomous traveling, when the vehicle 500 crosses the border from the country H to the country I, the autonomous traveling processing unit 122 switches the control rule to be referred to from the control rule for the country H to the control rule for the country I (step St07). The autonomous traveling processing unit 122 of the vehicle 500 after switching the control rule controls the autonomous traveling of the vehicle 500 according to a control rule corresponding to a traffic regulation for a driving priority order in a case where a plurality of vehicles are going to enter an intersection at substantially the same time in the country I. For example, the autonomous traveling processing unit 122 controls the autonomous driving of the vehicle 500 with reference to the following control rules.
The presence of an intersection in the traveling direction of the vehicle 500 is detected. This detection may be executed based on an image captured by the camera included in the sensor device 20, map information, GPS position information, and the like.
It is determined whether there is a sign described as “ALL WAY STOP” or “4 WAY STOP” at the detected intersection. This determination may be executed based on road sign information acquired by image recognition of a road sign shown in an image captured by the camera included in the sensor device 20.
When it is determined that there is a sign described as “ALL WAY STOP” or “4 WAY STOP” at the detected intersection, the vehicle control ECU 40 is controlled to decelerate the vehicle 500 and stop the vehicle 500.
The determination as to whether there is a vehicle traveling on the intersection road from the right is performed once or many times at predetermined time intervals. This determination may be executed based on an image captured by the camera included in the sensor device 20. As a result of this determination, when it is determined that there is no vehicle traveling on the intersection road from the right, the vehicle control ECU 40 is controlled to accelerate and advance the vehicle 500, and the vehicle 500 passes through the intersection.

The above-described control rules having the autonomous traveling processing unit 122 as a processing subject are merely examples, and the autonomous traveling processing unit 122 may control the autonomous driving of the vehicle 500 with reference to other control rules.

After switching the control rule to be referred to, the autonomous traveling processing unit 122 in the vehicle 500 controls traveling, a temporary stop, re-acceleration, and the like of the vehicle 500 according to the traffic regulation of the country I. As a result, the vehicle 500 can correctly pass through the intersection according to the traffic regulation of the country I. In addition, the vehicle 500 can avoid an unexpected accident such as the above-described collision, and perform safe autonomous traveling.

The above shows an example of switching of the control rule referred to by the autonomous traveling processing unit 122 when the vehicle 500 autonomously traveling in the country H enters the country I across the border. On the other hand, when the vehicle 500 autonomously traveling in the country I enters the country H across the border, the control rule referred to by the autonomous traveling processing unit 122 may be similarly switched (step St07).

As described above, the control unit is configured to switch the control content based on control rule information corresponding to a traffic regulation. The program causes the control device to function so as to switch the control content based on control rule information corresponding to a traffic regulation. In the step of switching the control content in the autonomous driving of the vehicle based on the position of the vehicle, the control method includes switching the control content based on control rule information corresponding to a traffic regulation. As described above, based on the position of the vehicle, the vehicle can safely autonomously travel according to the traffic regulation corresponding to the position.

In the above configuration, the control unit is configured to switch the control content in a case in which the vehicle crosses a border between regions having different traffic regulations. Accordingly, even when the vehicle autonomously travels across regions having different traffic regulations, the vehicle can safely autonomously travel according to the traffic regulations of the respective regions.

In the above configuration, before the vehicle crosses the border between the regions having the different traffic regulations, the control unit is configured to acquire control rule information corresponding to a traffic regulation of a region in which the vehicle travels after the vehicle crosses the border. Accordingly, it is possible to prepare a control rule corresponding to a traffic regulation of a region ahead of the border before the vehicle crosses the border, and it is possible to smoothly switch the control rule.

In the above configuration, the control unit is configured to switch, based on the position of the vehicle, traveling lane selection control and turn signal control of the vehicle at a roundabout intersection. Accordingly, even when the vehicle autonomously travels across regions having different traffic regulations for the roundabout intersection, the vehicle can safely autonomously travel according to the traffic regulations of the respective regions.

In the above configuration, the control unit is configured to switch, based on the position of the vehicle, traveling control of the vehicle for a temporary stop before a railroad crossing and a passage through the railroad crossing passage. Accordingly, even when the vehicle autonomously travels across regions having different traffic regulations for the railroad crossing, the vehicle can safely autonomously travel according to the traffic regulations of the respective regions.

In the above configuration, the control unit is configured to switch, based on the position of the vehicle, traveling control of the vehicle for a temporary stop at and an entry into an intersection where a red light is indicated in a traveling direction of the vehicle. Accordingly, even when the vehicle autonomously travels across regions having different traffic regulations for the red light of the intersection, the vehicle can safely autonomously travel according to the traffic regulations of the respective regions.

In the above configuration, the control unit is configured to switch, based on the position of the vehicle, traveling control of the vehicle for a temporary stop at and an entry into an intersection where a yellow light is indicated in a traveling direction of the vehicle. Accordingly, even when the vehicle autonomously travels across regions having different traffic regulations for the yellow light of the intersection, the vehicle can safely autonomously travel according to the traffic regulations of the respective regions.

In the above configuration, the control unit is configured to switch, based on the position of the vehicle, traveling control of the vehicle for a temporary stop at and an entry into an intersection based on a priority order of a plurality of vehicles allowed to pass through the intersection in a case where the plurality of vehicles enter the intersection from a plurality of directions. Accordingly, even when the vehicle autonomously travels across regions having different traffic regulations in the case where the plurality of vehicles enter the intersection from the plurality of directions, the vehicle can safely autonomously travel according to the traffic regulations of the respective regions.

In the vehicle configured as described above, the vehicle further includes notification means, and the control unit controls the notification means to notify an occupant of the vehicle that the control content has been switched in response to switching of the control content. Accordingly, it is possible to notify the occupant of the vehicle that the traffic regulation to be followed by the vehicle during autonomous traveling has changed.

Although various embodiments have been described above with reference to the drawings, it is needless to say that the present invention is not limited thereto. It will be apparent to those skilled in the art that various changes and modifications can be conceived within the scope of the claims, and it is also understood that the various changes and modifications belong to the technical scope of the invention. In addition, the respective components in the above-described embodiments may be optionally combined within a range not departing from the scope of the present invention.

The present application is based on Japanese Patent Application No. 2019-234064 filed on Dec. 25, 2019, and the contents thereof are incorporated herein by reference.

The present disclosure is useful when internal control of a vehicle is switched according to a current position of the vehicle.

What is claimed is:

1. A control device for controlling autonomous driving of a vehicle, the control device comprising:
a processor; and
a memory storing instructions that, when executed by the processor, cause the control device to perform operations comprising:
switching a control content in the autonomous driving of the vehicle based on a position of the vehicle.

2. The control device according to claim 1,
wherein the control content is based on control rule information corresponding to a traffic regulation.

3. The control device according to claim 1,
wherein the switching the control content comprises switching the control content in a case in which the vehicle crosses a border between regions having different traffic regulations.

4. The control device according to claim 3,
wherein the operations further comprise acquiring, before the vehicle crosses the border between the regions having the different traffic regulations, control rule information corresponding to a traffic regulation of a region in which the vehicle travels after the vehicle crosses the border.

5. The control device according to claim 4,
wherein the control content is based on control rule information corresponding to a traffic regulation.

6. The control device according to claim 4,
wherein the acquiring the control rule information comprises:
determining whether the vehicle approaches the border by a prescribed distance; and
acquiring the control rule information in response to determining that the vehicle approaches the border by the prescribed distance.

7. The control device according to claim 4,
wherein the operations further comprise:
acquiring autonomous driving rule information corresponding to a traffic regulation; and
interpreting the autonomous driving rule information to acquire the control rule information.

8. The control device according to claim 7,
wherein the autonomous driving rule information is a bundle of a plurality of kinds of the control rule information.

9. The control device according to claim 7,
wherein the autonomous driving rule information has a format in which condition determinations corresponding to clauses in the traffic regulation is expressed in a structured form.

10. The control device according to claim 1,
wherein the switching the control content comprises switching, based on the position of the vehicle, traveling lane selection control and turn signal control of the vehicle at a roundabout intersection.

11. The control device according to claim 1,
wherein the switching the control content comprises switching, based on the position of the vehicle, traveling control of the vehicle for a temporary stop before a railroad crossing and a passage through the railroad crossing.

12. The control device according to claim 1,
wherein the switching the control content comprises switching, based on the position of the vehicle, traveling control of the vehicle for a temporary stop at and an entry into an intersection where a red light is indicated in a traveling direction of the vehicle.

13. The control device according to claim 1,
wherein the switching the control content comprises switching, based on the position of the vehicle, traveling control of the vehicle for a temporary stop at and an entry into an intersection where a yellow light is indicated in a traveling direction of the vehicle.

14. The control device according to claim 1,
wherein the switching the control content comprises switching, based on the position of the vehicle, traveling control of the vehicle for a temporary stop at and an entry into an intersection based on a priority order of a plurality of vehicles allowed to pass through the intersection in a case where the plurality of vehicles enter the intersection from a plurality of directions.

15. A vehicle comprising the control device according to claim 1.

16. The vehicle according to claim 15, further comprising:
an output device,
wherein the operations further comprise controlling the output device to notify an occupant of the vehicle that the control content has been switched in response to switching of the control content.

17. A non-transitory computer-readable medium storing a program that, when executed by a processor, causes a control device included in a vehicle to perform operations comprising switching a control content in autonomous driving of the vehicle based on a position of the vehicle.

18. The non-transitory computer-readable medium according to claim 17,
wherein the control content is based on control rule information corresponding to a traffic regulation.

19. A control method for controlling autonomous driving of a vehicle and to be executed by a control device, the control method comprising:
acquiring a position of the vehicle; and
switching a control content in the autonomous driving of the vehicle based on the position of the vehicle.

20. The control method according to claim 19,
wherein the control content is based on control rule information corresponding to a traffic regulation.
